(19) United States
(12) Patent Application Publication
(10) Pub. No.: US 2024/0415136 A1
(43) Pub. Date: Dec. 19, 2024

(54) Process for Producing Substantially Lactose Free Milk, and Substantially Lactose Free Milk Obtainable by Said Process

(71) Applicant: Ausnutria B.V., Zwolle (NL)

(72) Inventor: Mattia Boiani, Zwolle (NL)

(21) Appl. No.: 18/719,101

(22) PCT Filed: Dec. 29, 2022
(86) PCT No.: PCT/NL2022/050765

§ 371 Date: Jun. 12, 2024

(30) Foreign Application Priority Data
Dec. 31, 2021 (NL) 2030385

(51) Int. Cl. A23C 9/12; A23C 9/142

(52) U.S. Cl. CPC A23C 9/1206; A23C 9/1422; A23C 9/1425

(57) ABSTRACT

The invention relates to a process for producing substantially lactose free milk, and substantially lactose free milk obtainable by said process. The process comprises the steps of: a) ultra-filtering of milk providing a UF-permeate stream and a UF-retentate stream; b) hydrolysing the UF-retentate by means of lactase; c) nano-filtering the UF-permeate providing a NF-permeate stream and a NF-retentate stream; and d) mixing the hydrolysed UF-retentate stream of step b) with the NF-permeate stream of step c) providing a lactose free or substantially lactose free milk.

### FIELD OF THE INVENTION

The present invention relates to a process for producing lactose free or substantially lactose free milk, a lactose free milk or substantially lactose free milk obtained by the process, lactose free milk or substantially lactose free milk products obtained by the process, use of the lactose free milk or substantially lactose free milk, use of the lactose free milk or substantially lactose free milk products, and system for producing lactose free milk or substantially lactose free milk.

### BACKGROUND OF THE INVENTION

Lactose intolerance is commonly observed in Asia and Africa, where 90% or more of the adult population suffers from lactose intolerance. In Western-Europe, Australia and North-America 5-15% of adult population suffers from lactose intolerance. This difference is likely due to a mutation resulting in sufficient lactase being produced into adulthood.

During the lactation period all new-born mammals produce the enzyme lactase which cleaves di-saccharide lactose into D-galactose and D-glucose. D-galactose and D-glucose can then be metabolised. During the weaning period from mothers milk the production of lactase decreases. Individuals having the mutation are able to digest lactose in milk into adulthood. Nowadays milk and milk products such as yoghurt, cheese, ice-cream, milk based sport-drinks and so one are part of the daily diet of many individuals as these products provide important nutrients such as calcium, phosphorus, vitamin B12, potassium and vitamin D. It is well known that milk and other dairy products help to prevent osteoporosis and bone fractions. Individuals suffering from lactose intolerance tend to eliminate dairy products from their diet as much as possible. Elimination of dairy products from the diet however can lead to nutritional deficiencies, especially of protein, fat, calcium, phosphorus, and vitamin B12.

Over the last few years much effort has been invested in providing lactose free milk and lactose free milk products. To achieve such products several processes have been developed for removing lactose from milk. A well-known process to remove lactose is by treating milk with lactase thereby hydrolysing lactose into glucose and galactose. To end the hydrolysing process the lactase is deactivated by heat treatment. A complication of such obtained lactose free milk is the unacceptably sweet taste of the milk caused by the hydrolysation of lactose into the monosaccharides glucose and galactose. In order to circumvent this issue processes have been developed to reduce the amount of lactose in the milk before lactase is added.

Such processes have been described in EP 1503630 B1, for example.

EP 2207428 B1 further simplified the process by ultrafiltration of milk after which the obtained permeate is nano-filtered, the retentate of the ultrafiltration and the permeate of the nanofiltration being mixed after which the remaining lactose in the mixture is being hydrolysed.

A problem of the above described processes is the long retention time for hydrolysing the lactose in the milk. Another problem of the above described processes is the difficulty to determine the right amount of lactase dosage for optimal lactose removal. As is known by the person skilled in the art the amount of lactose in milk varies during the year and thus the amount of lactase to be added to hydrolyse the lactose will need to be adjusted. A further problem is the unacceptably sweet taste of lactose free milk due to the hydrolysation of lactose into glucose and galactose.

These problems prevent an efficient and effective process for producing lactose free milk having a regular milk taste. These problems are even bigger for large scale production of lactose free milk.

An objective of the present invention is to provide a process for producing lactose free or substantially lactose free milk, that obviates or at least reduces the aforementioned problems and is more effective and/or efficient as compared to conventional processes.

### SUMMARY OF THE INVENTION

This objective is achieved by providing, in a first aspect, a more efficient process for producing lactose free milk or substantially lactose free milk, comprising the steps of:
a) ultra-filtering of milk providing an ultra-filtration permeate (UF-permeate) stream and an ultra-filtration retentate (UF-retentate) stream;
b) hydrolysing the UF-retentate by means of lactase;
c) nano-filtering the UF-permeate providing a nano-filtration permeate (NF-permeate) stream and a nano-filtration retentate (NF-retentate) stream; and
d) mixing the hydrolysed UF-retentate stream with the NF-permeate stream providing a lactose free milk or substantially lactose free milk.

The present invention provides a method for producing lactose free milk or substantially lactose free milk as defined herein, further comprising a second filtration step from the first retentate stream for filtering the first NF-retentate stream providing a second NF-retentate stream and a second NF-permeate stream.

In a further particular embodiment, the present invention provides a method for producing lactose free milk or substantially lactose free milk as defined herein, further comprising a third filtration step from the second retentate stream for filtering the second NF-retentate stream providing a third NF-retentate stream and a third NF-permeate stream.

In a further particular embodiment, the present invention provides a method for producing lactose free milk or substantially lactose free milk as defined herein, the NF-permeate stream may be provided to the UF-permeate.

In a further particular embodiment, the present invention provides a method for producing lactose free milk or substantially lactose free milk as defined herein, at least part of the NF-permeate streams may be provided to the UF-permeate.

In a further particular embodiment, the present invention provides a method for producing lactose free milk or substantially lactose free milk as defined herein, further comprising a measurement step wherein the measurement step comprises measuring the concentration of one or more elements selected from the group of natrium, magnesium, calcium, protein, lactose, phosphorous, dry matter and/or ash.

In a further particular embodiment, the present invention provides a method for producing lactose free milk or substantially lactose free milk as defined herein, further comprising a controlling step of the UF-permeate stream and/or UF-retentate stream based on the measurement of the concentration of natrium, magnesium, calcium, protein, lactose, and/or phosphorous.

In a further particular embodiment, the present invention provides a method for producing lactose free milk or substantially lactose free milk as defined herein, using a volume concentration factor in the range of 3.5 to 6.5, preferably in the range of 3.7 to 5.5, most preferably in the range of 4 to 5, to provide the NF-retentate stream and NF-permeate stream of step c).

In a further particular embodiment, the present invention provides a method for producing lactose free milk or substantially lactose free milk as defined herein, using a volume concentration factor in the range of 2.5 to 6.5 to provide the second NF-retentate stream and/or second NF-permeate stream.

In a further particular embodiment, the present invention provides a method for producing lactose free milk or substantially lactose free milk as defined herein, using a volume concentration factor in the range of 2.5 to 6.5 to provide the third NF-retentate stream and third NF-permeate stream.

In a further particular embodiment, the present invention provides a method for producing lactose free milk or substantially lactose free milk as defined herein, wherein the step of hydrolysing the UF-retentate may be performed at a temperature range of 4° C. to 10° C., preferably in the range of 5° C. to 8° C., more preferably in the range of 6° C. to 7° C.

In a further particular embodiment, the present invention provides a method for producing lactose free milk or substantially lactose free milk as defined herein, wherein the step of hydrolysing the UF-retentate may be performed for at most 24 hours, preferably for at most 20 hours, more preferably about 16 hours.

In a further particular embodiment, the present invention provides a method for producing lactose free milk or substantially lactose free milk as defined herein, wherein the step of nano-filtering the UF-permeate may be performed at a temperature range of 4° C. to 15° C.

In a further particular embodiment, the present invention provides a method for producing lactose free milk or substantially lactose free milk as defined herein, wherein the step of ultra-filtering may be performed at a concentration factor in the range of 1.8 to 2.2, preferably in the range of 1.9 to 2.1, more preferably at a concentration factor of about 2.

In a further particular embodiment, the present invention provides a method for producing lactose free milk or substantially lactose free milk as defined herein, wherein the step of ultra-filtering may be performed at a temperature range from 45° C. to 55° C.

In a second aspect, the invention provides for a lactose free milk or substantially lactose free milk obtained by the process.

In a particular embodiment, the present invention provides a lactose free milk or substantially lactose free milk as defined herein, the concentration of lactose may be less than 0.05 wt %, preferably less than 0.02 wt %, more preferably less than 0.01 wt %.

In a further particular embodiment, the present invention provides a lactose free milk or substantially lactose free milk as defined herein, the concentration of ash may be in the range of 0.6 g/100 ml to 1.1 g/100 ml.

In a further particular embodiment, the present invention provides a lactose free milk or substantially lactose free milk as defined herein, the concentration of dry matter may in the range of 8.5 g/100 ml to 10 g/100 ml.

In a further particular embodiment, the present invention provides a lactose free milk or substantially lactose free milk as defined herein, the concentration of calcium is 100 mg/100 ml to 135 mg/100 ml.

In a further particular embodiment, the present invention provides a lactose free milk or substantially lactose free milk as defined herein, the concentration of phosphorus is 90 mg/100 ml to 120 mg/100 ml.

In a third aspect, the invention provides for a lactose free milk product or substantially lactose free milk product, such as infant formula, adult formula, yoghurt comprising the lactose free milk.

In a fourth aspect, the invention provides for a use of the lactose free milk or substantially lactose free milk according to the invention, or lactose free milk or substantially lactose free milk product to prevent or relieve disorders caused by lactose intolerance.

In other words the invention provides lactose free milk or substantially lactose free milk according to the invention, or lactose free milk or substantially lactose free milk product, for use in a method to prevent or relieve disorders caused by lactose intolerance.

In a fifth aspect, the invention provides for a system for producing lactose free milk or substantially lactose free milk, comprising:
a milk tank;
an ultra-filtration device (UF-device) arranged to receive a milk stream and configured to provide a UF-permeate stream and a UF-retentate stream;
a hydrolysing tank arranged to receive and hydrolyse said UF-retentate stream and provide a hydrolysed UF-retentate stream;
a nano-filtration device (NF-device) comprising at least one nano-filtration stage (NF-stage) configured to receive said UF-permeate stream and to provide a NF-permeate stream and a NF-retentate stream; and
a lactose free milk tank configured to receive and combine said NF-permeate stream with said hydrolysed UF-retentate stream into said lactose free milk.

In a particular embodiment, the present invention provides a system for producing lactose free milk or substantially lactose free milk as defined herein, further comprising a further NF-stage 113, 116 wherein each following NF-stage 113, 116 is configured to receive the NF-retentate stream of the previous NF-stage 110, 113 and each NF-permeate stream 112, 115, 118 is configured to be delivered to the lactose free milk tank 107 and/or to the UF-permeate stream.

In a further particular embodiment, the present invention provides a system for producing lactose free milk or substantially lactose free milk as defined herein, further comprising valve means 119, 120, 121 configured to separate each permeate stream 112, 115, 118, wherein each separated permeate stream 112a, 112b, 115a, 115b, 118a, 118b is configured to be delivered to the lactose free milk tank 107 or to the UF-permeate stream.

### DETAILED DESCRIPTION OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Accordingly, as already defined herein above, the present invention relates to a process for producing lactose free milk or substantially lactose free milk, comprising the steps of:
a) ultra-filtering of milk providing a UF-permeate stream and a UF-retentate stream;
b) hydrolysing the UF-retentate by means of lactase;
c) nano-filtering the UF-permeate providing a NF-permeate stream and a NF-retentate stream; and
d) mixing the hydrolysed UF-retentate stream with the NF-permeate stream providing a lactose free or substantially lactose free milk.

The current process results in a more efficient process. Ultrafiltration is a first step in reducing the amount of lactose in the milk. The decreased lactose content in the UF-retentate stream provides for the use of less lactase enzyme to hydrolyse the lactose into glucose and galactose. Lowering the lactose concentration before the hydrolysation step results in less lactose to be hydrolysed into glucose and galactose. Glucose and galactose are the main factors leading to the unwanted sweetness often observed in lactose free milk. Thus, the lower amounts of lactose to start with, the lower the amount of glucose and galactose are obtained in the hydrolysed milk.

The lactose and minerals containing UF-permeate is subjected to a nano-filtration device for nano-filtering the UF-permeate. The nano-filtration device may comprise one, two, three or further nanofiltration steps. Nano-filtration reduces the lactose in the mineral stream resulting in a NF-retentate stream comprising mostly lactose and water and a NF-permeate stream comprising minerals. The lactose reduced minerals comprising NF-permeate stream is then combined with the hydrolysed UF-retentate stream which provide a lactose free milk or substantially lactose free milk having a regular milk taste due to the combining of the minerals stream and the hydrolysed UF-retentate stream. By combining the hydrolysed UF-retentate stream with the lactose removed minerals containing NF-permeate stream the organoleptic characteristics important for maintaining a regular milk taste remained in the lactose free milk or substantially lactose free milk.

According to a preferred aspect, the process comprises a second NF-filtration step in the NF-device. The second NF-filtration step is fed from the first NF-retentate stream. This second NF-filtration step provides a second NF-retentate stream and a second NF-permeate stream. The additional second nanofiltration step results in a reduced lactose content and more concentrated minerals stream.

According to another preferred aspect, the process further comprises a third NF-filtration step from the second NF-retentate stream. This third NF-filtration step provides a third NF-retentate stream and a third NF-permeate stream within the NF-device. The skilled person acknowledges that any further NF-filtration step can be added within the NF-device to further concentrate the minerals stream where and when needed. The additional nanofiltration step results in an even more concentrated minerals stream.

The concentrated or more concentrated minerals stream of the nanofiltration steps can be used to improve the taste of the lactose free milk or substantially lactose free milk to obtain a lactose free milk or substantially lactose free milk with regular milk taste.

According to yet another preferred aspect, the NF-permeate stream is provided to the UF-permeate. A controller switch or valve or any other valve or switching means can be used to provide the NF-permeate stream to either the lactose free milk tank or to the UF-permeate. The UF-permeate and NF-permeate that are fed to the NF-device to be nano-filtered serve to tune the differences in lactose concentration.

As already mentioned, the lactose concentration in milk differs throughout the year. Providing the NF-permeate to the UF-permeate results in a dynamic system that can tune the differences in the lactose and/or minerals concentration to keep the lactose and minerals concentration as stable as possible by providing the NF-permeate to either the lactose free milk tank or to the UF-permeate.

According to yet another preferred aspect, at least part of the NF-permeate streams is provided to the UF-permeate. Depending on the concentration of lactose and minerals in the milk adaptation by providing at least 1%, 5%, 10%, 20%, 30%, 40%, 50%, 60%, 70%, 80%, 90% or 95% of the NF-permeate to the UF-permeate is performed to keep the lactose and/or minerals concentration at a stable level. By using at least part of the NF-permeate stream, for instance at least 1%, 5%, 10%, 20%, 30%, 40%, 50%, 60%, 70%, 80%, 90% or 95%, the system becomes more flexible in fine tuning the lactose and mineral concentration fed to the NF-device.

According to yet another preferred aspect, a measurement step is provided wherein the measurement step comprises measuring the concentration of one or more selected from the group of natrium, magnesium, calcium, lactose, phosphorous, dry matter and/or ash. The measurement of the concentration of one or more elements selected from the group of natrium, magnesium, calcium, lactose, phosphorous, dry matter, and/or ash in the NF-permeate can be performed by any method of measurement of these components known to the skilled person. Based on the outcome of the measurement and the concentration of lactose and/or minerals in the UF-permeate stream it can be decided whether 0%, 1%, 5%, 10%, 20%, 30%, 40%, 50%, 60%, 70%, 80%, 90%, 95% or 100% of the NF-permeate is to be provided to the lactose free milk tank or to the UF-permeate stream.

According to yet another preferred aspect, a controlling step of the UF-permeate stream and/or UF-retentate stream is provided based on the measurement of the concentration of natrium, magnesium, calcium, lactose, phosphorous ash and/or dry matter. The controlling step involves means for opening and/or closing a valve or switch or any similar means known to the skilled person to provide the UF-permeate stream either fully or in part or not at all to either the lactose free milk tank or to the UF-permeate stream.

According to yet another preferred aspect, a volume concentration factor in the range of 3.5-6.5; is used, preferably in the range of 3.7 to 5.5, most preferably in the range of 4 to 5, to provide the NF-retentate stream and NF-permeate stream of step c).

According to yet another preferred aspect, further comprising more than one NF-step a volume concentration factor in the range of 2.5 to 6.5 is used to provide the second NF-retentate stream and/or second NF-permeate stream.

According to yet another preferred aspect, further comprising more than one NF-step a volume concentration factor in the range of 2.5 to 6.5 is used to provide the third NF-retentate stream and/or third NF-permeate stream. Any further NF-step may be performed to the NF-device where needed to improve the concentration step of the minerals stream.

In a further aspect hydrolysing the UF-retentate is performed at a temperature range of 4° C. to 10° C., preferably in the range of 5° C. to 8° C., more preferably in the range of 6° C. to 7° C.

In a further aspect, hydrolysing the UF-retentate is performed for at most 24 hours, preferably for at most 20 hours, more preferably about 16 hours.

In a further aspect, the step of nano-filtering the UF-permeate is performed at a temperature range of 4° C. to 15° C.

In a further aspect, the step of ultra-filtering is performed at a concentration factor in the range of 1.8 to 2.2, preferably in the range of 1.9 to 2.1, more preferably at a concentration factor of about 2.

In a further aspect, the step of ultra-filtering is performed at a temperature range from 45° C. to 55° C.

In an embodiment a lactose free milk or substantially lactose free milk is obtained according to the process of the invention.

In a preferred embodiment, the concentration of lactose in the lactose free or substantially lactose free milk is less than 0.05 wt %, 0.04 wt %, 0.03 wt %, 0.02 wt %, 0.01 wt %, preferably less than 0.02 wt %, more preferably less than 0.01 wt %. The lactose content may be determined by any method known to the skilled person.

In a preferred embodiment, the concentration of ash in the lactose free milk or substantially lactose free milk is in the range of 0.6 g/100 ml to 1.1 g/100 ml.

In a preferred embodiment, the concentration of dry matter in the lactose free milk or substantially lactose free milk is in the range of 8.5 g/100 ml to 10 g/100 ml.

In yet another preferred embodiment, the concentration of calcium in the lactose free milk or substantially lactose free milk is 100 mg/100 ml to 135 mg/100 ml.

In yet another a preferred embodiment, the concentration of phosphorus in the lactose free milk or substantially lactose free milk is 90 mg/100 ml to 120 mg/100 ml.

Another embodiment of the invention is a lactose free milk product or substantially lactose free milk product selected from the group of infant formula, adult formula, yoghurt, comprising the lactose free milk or substantially lactose free milk obtained according to the process of the invention.

Another aspect of the invention is the use of the lactose free milk or substantially lactose free milk, or the lactose free milk product or substantially lactose free milk product obtained according to the process of the invention, to prevent or relieve disorders caused by lactose intolerance. Therefore, the provided milk or milk product may be used by lactose intolerant humans and/or animals without suffering from the problems normally encountered when drinking regular milk or milk products.

Yet another aspect of the invention is a system for producing lactose free milk or substantially lactose free milk, comprising:
a milk tank;
a UF-device arranged to receive a milk stream and configured to provide a UF-permeate stream and a UF-retentate stream;
a hydrolysing tank arranged to receive and hydrolyse said UF-retentate stream and provide a hydrolysed UF-retentate stream;
a NF-device comprising at least one NF-stage configured to receive said UF-permeate stream and to provide a NF-permeate stream and a NF-retentate stream; and
a lactose free milk tank configured to receive and combine said NF-permeate stream with said hydrolysed UF-retentate stream into said lactose free milk.

In a preferred aspect, the system comprises a further NF-stage wherein each following NF-stage is configured to receive the NF-retentate stream of the previous NF-stage and each NF-permeate stream is configured to be delivered to the lactose free milk tank and/or to the UF-permeate stream. Depending on the lactose and/or minerals concentration of the milk delivered to the system, which may for instance depend on whether the milk is collected in winter or summer time, the system may be fine-tuned to work as efficiently possible. By changing the feed of the NF-permeate to either the lactose free milk tank or to the UF-permeate stream the final concentration of minerals in the lactose free or substantially lactose free milk may be adjusted.

### BRIEF DESCRIPTION OF THE DRAWINGS

Further advantages, features and details of the invention are elucidated on the basis of preferred aspects thereof, wherein reference is made to the accompanying drawings, in which:

FIG. 1 shows a schematic overview of a method for producing lactose free milk or substantially lactose free milk according to the invention;

FIG. 2 shows a schematic overview of the system according to the invention comprising a single nano-filtering step;

FIG. 3 shows a schematic overview of the system according to the invention comprising multiple nano-filtering steps;

FIG. 4 shows a schematic overview of the system according to the invention comprising splitting of the NF-permeate stream;

FIG. 5 shows results obtained from the filtration process;

FIG. 6 shows results obtained from the hydrolysis process; and

FIG. 7 show the lactose content in the milk plotted against time of hydrolysation.

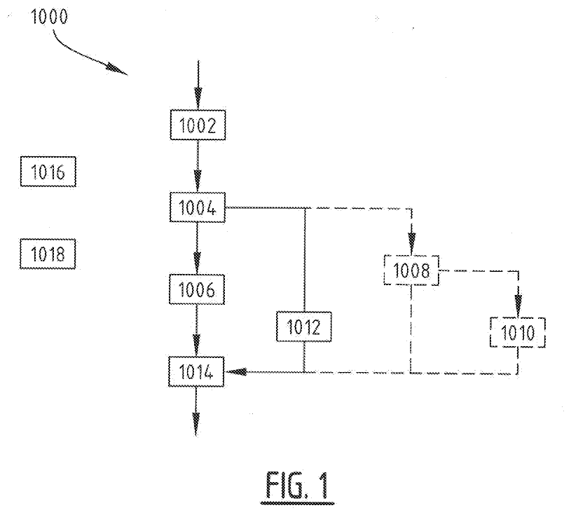

Method 1000 (FIG. 1) for producing lactose free milk or substantially lactose-free milk follows a sequence of different steps. In the illustrated embodiment method 1000 optionally starts with step 1002 of providing milk. Step 1002 may be followed by step 1004 of ultra-filtering of milk providing a UF-permeate stream and a UF-retentate stream.

Furthermore, step 1004 may be followed by step 1006 of hydrolysing the UF-retentate by means of lactase and/or step 1012 of nano-filtering the UF-permeate providing a NF-permeate stream and a NF-retentate stream. Optionally, step 1008 of a second filtration from the first retentate stream for filtering the first NF-retentate stream providing a second NF-retentate stream and a second NF-permeate stream and/or step 1010 of a third filtration step from the second retentate stream for filtering the second NF-retentate stream providing a third NF-retentate stream and a third NF-permeate stream may be performed in addition to step 1012.

The hydrolysed UF-retentate stream of step 1006 may then be combined with the NF-retentate stream of step 1012 and/or step 1008 and/or step 1010 and mixed in step 1014 of mixing the hydrolysed UF-retentate stream with the NF-permeate stream providing a lactose free or substantially lactose free milk.

Optionally, method 1000 further comprises measurement step 1016 comprising comprises measuring the concentration of one or more element selected from the group of natrium, magnesium, calcium, protein, lactose, phosphorous, dry matter, and ash. Preferably, method 1000 also comprises controlling step 1018 of controlling of the UF-permeate stream and/or UF-retentate stream based on the measurement of the concentration of natrium, magnesium, calcium, protein, lactose, phosphorous, dry matter, and/or ash.

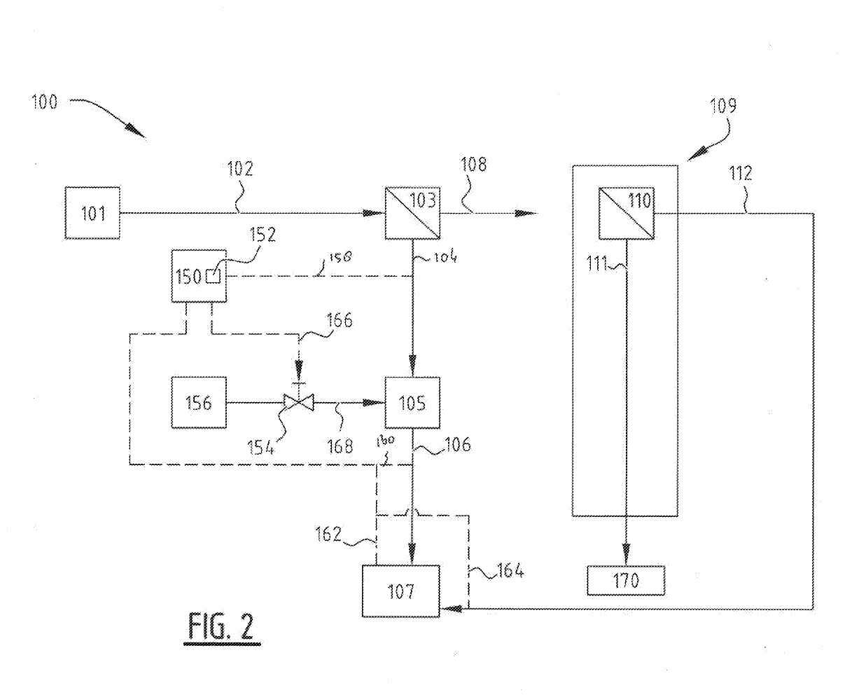

In an illustrated embodiment system 100 (FIG. 2) for producing lactose free milk or substantially lactose free milk, comprises a milk tank 101, from which the milk stream 102 is provided to a UF-device 103. The UF-device being configured to provide a UF-permeate stream 108 and a UF-retentate stream 104. A hydrolysing tank 105 arranged to receive and hydrolyse said UF-retentate stream 104 and provide a hydrolysed UF-retentate stream 106. A NF-device 109 comprising at least one NF-stage 110 is configured to receive the UF-permeate stream 108 and to provide a NF-permeate stream 112 and a NF-retentate stream 111. A lactose free milk tank 107 is configured to receive and combine the NF-permeate stream 112 with the hydrolysed UF-retentate stream 106 into lactose free milk.

Optionally, the system 100 comprises a controller 150 comprising a measuring device 152, wherein the controller 150 and the measuring device 152 are configured for measuring the concentration of one or more elements selected from the group of natrium, magnesium, calcium, protein, lactose, phosphorous, dry matter, and ash and/or controlling step of the UF-permeate stream and/or UF-retentate stream. For example, the controller 150 may provide input, via a connector 166, to a control valve 154 which is configured for controlling the input of a lactase stream 168 from a lactase tank 156. Said lactase stream 168 may be provided to the hydrolysing tank 105.

Furthermore, the controller 150 comprising the measuring device 152 may be operatively connected with the UF-retentate stream 104 via a connector 158, the hydrolysed UF-retentate stream 106 via a connector 160, the lactose free milk tank 107 via a connector 162, and/or the NF-permeate stream 112 via a connector 164. For example, the controller 150 may provide input, via a connector 166, to a control valve 154 which is configured for controlling the input of a lactase stream 168 from a lactase tank 156. The system 100 may further comprise a waste 170.

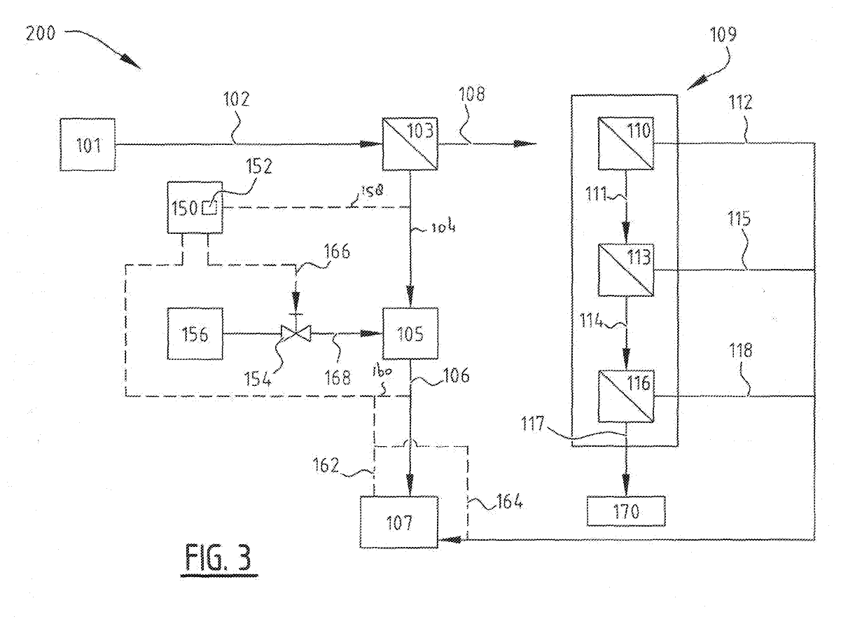

In another illustrated embodiment system 200 (FIG. 3) for producing lactose free milk or substantially lactose free milk, comprises a milk tank 101, from which the milk stream 102 is provided to a UF-device 103. The UF-device being configured to provide a UF-permeate stream 108 and a UF-retentate stream 104. A hydrolysing tank 105 arranged to receive and hydrolyse said UF-retentate stream 104 and provide a hydrolysed UF-retentate stream 106. A NF-device 109 comprising multiple NF-stages 110, 113, 116. The first NF-stage 110 is configured to receive the UF-permeate stream 108 and to provide a NF-permeate stream 112 and a NF-retentate stream 111. The second NF-stage 113 is configured to receive the NF-retentate stream 111 and to provide a NF-permeate stream 115 and a NF-retentate stream 114. The third NF-stage 116 is configured to receive the NF-retentate stream 114 and to provide a NF-permeate stream 118 and a NF-retentate stream 117. Any further NF-stages may be added to the NF-device 109 accordingly. A lactose free milk tank 107 is configured to receive and combine the NF-permeate stream 112, 115, 118 with the hydrolysed UF-retentate stream 106 into lactose free milk.

Optionally, the system 200 comprises a controller 150 comprising a measuring device 152, wherein the controller 150 and the measuring device 152 are configured for measuring the concentration of one or more element selected from the group of natrium, magnesium, calcium, protein, lactose, phosphorous, dry matter, and ash and/or controlling step of the UF-permeate stream and/or UF-retentate stream. For example, the controller 150 may provide input, via a connector 166, to a control valve 154 which is configured for controlling the input of a lactase stream 168 from a lactase tank 156. Said lactase stream 168 may be provided to the hydrolysing tank 105.

Furthermore, the controller 150 comprising the measuring device 152 may be operatively connected with the UF-retentate stream 104 via a connector 158, the hydrolysed UF-retentate stream 106 via a connector 160, the lactose free milk tank 107 via a connector 162, and/or the NF-permeate stream 112, 115, 118 via a connector 164. The system 200 may further comprise a waste 170.

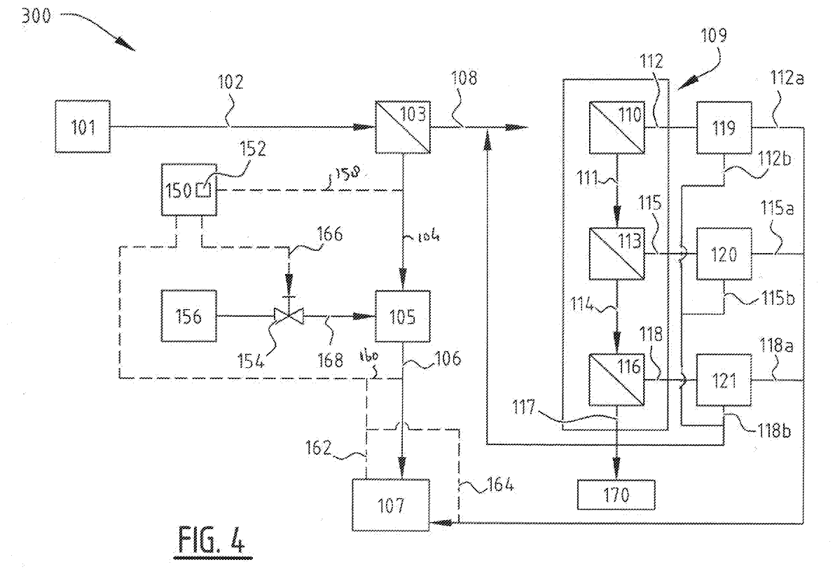

In yet another illustrated embodiment system 300 (FIG. 4) for producing lactose free milk or substantially lactose free milk, comprises a milk tank 101, from which the milk stream 102 is provided to a UF-device 103. The UF-device being configured to provide a UF-permeate stream 108 and a UF-retentate stream 104. A hydrolysing tank 105 arranged to receive and hydrolyse said UF-retentate stream 104 and provide a hydrolysed UF-retentate stream 106. A NF-device 109 comprising multiple NF-stages 110, 113, 116. The first NF-stage 110 is configured to receive the UF-permeate stream 108 and to provide a NF-permeate stream 112 and a NF-retentate stream 111. The NF-permeate stream passing through a valve 119 splitting the NF-permeate stream 112 in two separate streams 112a, 112b. Wherein one of the streams 112a is flowing to the lactose free milk tank 107 and the other stream 112b is flowing back to be combined with the UF-permeate stream 108.

The second and third NF-permeate stream 115, 118 passing through a respective valve 120, 121 splitting the NF-permeate stream 115, 118 in separate streams 115a, 115b, 118a, 118b. This enables providing the entire stream(s) or part of the stream(s) to the first NF stage, wherein one of the streams 115a, 118a is flowing to the lactose free milk tank 107 and the other stream 115b, 118b is flowing back to be combined with the UF-permeate stream 108. Any further NF-stages comprising such valves splitting the NF-permeate stream may be added to the NF-device 109 accordingly. A lactose free milk tank 107 is configured to receive and combine the NF-permeate stream 112a, 115a, 118a with the hydrolysed UF-retentate stream 106 into lactose free milk.

Optionally, the system 200 comprises a controller 150 comprising a measuring device 152, wherein the controller 150 and the measuring device 152 are configured for measuring the concentration of one or more element selected from the group of natrium, magnesium, calcium, protein, lactose, phosphorous, dry matter, and ash and/or controlling step of the UF-permeate stream and/or UF-retentate stream. For example, the controller 150 may provide input, via a connector 166, to a control valve 154 which is configured for controlling the input of a lactase stream 168 from a lactase tank 156. Said lactase stream 168 may be provided to the hydrolysing tank 105.

Furthermore, the controller 150 comprising the measuring device 152 may be operatively connected with the UF-retentate stream 104 via a connector 158, the hydrolysed UF-retentate stream 106 via a connector 160, the lactose free milk tank 107 via a connector 162, and/or the NF-permeate stream 112a, 115a, 118a via a connector 164. The system 300 may further comprise a waste 170.

### Examples

### Filtration Process

600 litres of skimmed goat milk were fed to a batch filtration unit, equipped with an ultrafiltration spiral wound membrane (Alfa Laval, GR73PP). Process was stopped once 300 litres of permeate were collected (equal to a concentration factor of 2). The permeate was divided into three different batches of 100 litres each. The batches were further feed to the batch filtration unit, equipped with a nanofiltration spiral wound membrane (SUEZ, Dairy DK3838C30).

The first UF-permeate batch was processed using a total concentration factor of 5. The first NF-permeate of 60 litres, concentration factor of 2.5, was collected separately from the second permeate (the remaining 20 litres). The second NF-permeate was mixed with the second batch of UF-permeate generating the second NF feed. Furthermore, the second NF feed was processed using a total concentration factor of 6. The first permeate of 80 litres, concentration factor of 3, was collected separately from the second permeate (the remaining 20 litres). The second NF-permeate was mixed with the third batch of UF-permeate to generate the third NF feed.

The third NF feed was processed using a total concentration factor of 6. The first permeate of 80 litres, concentration factor of 3, was collected separately from the second permeate (the remaining 20 litres). The second NF-permeate was discarded. The NF-permeates from each nanofiltration process were mixed and used to dilute the UF retentate during and/or after the lactose hydrolysis.

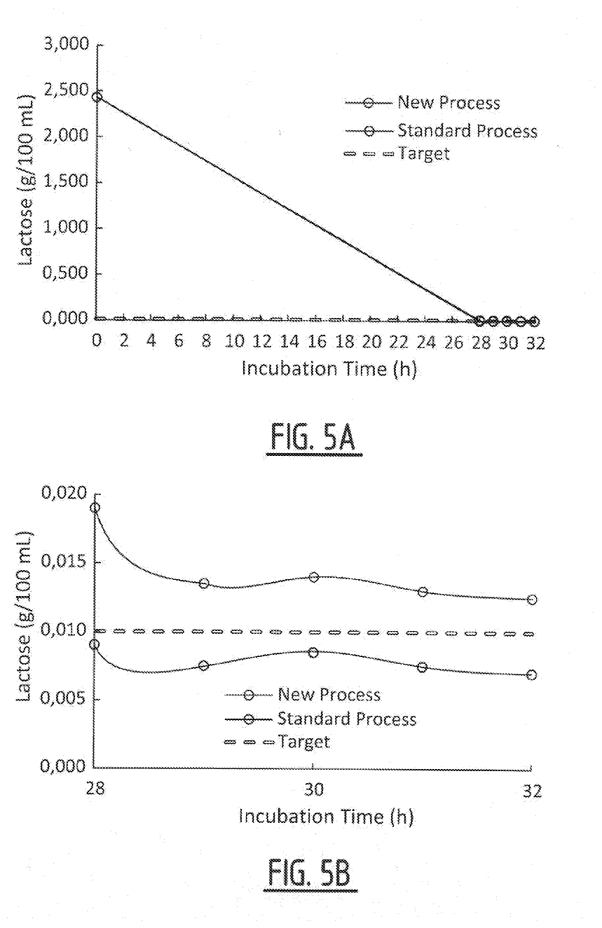

The results obtained from the filtration process are shown in FIG. 5. From these results it becomes clear and evident that lactose is reduced in the NF-permeate samples while the minerals remain present.

### Hydrolysis

2 litres of UF-retentate, collected from the UF process, were pasteurized (85° C. for 15 seconds), and divided into two equal parts. One litre of UF-retentate was diluted using 0.8 L of NF-permeate while the second litre was retained at its current concentration. The diluted UF-retentate represent the standard process, while the undiluted sample will represent the new process. Lactose hydrolysis was achieved using lactase enzymes. Both materials were inoculated using a similar lactase:lactose content/ratio.

The reactor was kept at 4° C. for 24 to 32 hours. Samples were collected at the same time from both reactors. The new process samples were diluted with a 1:0.8 ratio using the same NF-permeate used to dilute the UF-retentate. Enzyme was deactivated at 90° C. and the samples were analysed for their lactose content using an HPLC method.

Bigger volume hydrolyses were obtain similarly using 400 litres of UF-retentate. The UF-retentate was divided in four equals parts. For the traditional process, two 100 litres parts were diluted using 80 litres of NF-permeate. For the new process, the two 100 litres parts were hydrolysed without any dilution. Lactose hydrolysis was achieved using lactase enzymes. Both the standard process and the new process was inoculated using a similar lactase:lactose content/ratio.

The reactors were kept at 4° C. for 24 hours. The new process samples were diluted with a 1:0.8 ratio using the same NF-permeate used to dilute the UF-retentate. The enzyme was deactivated at 90° C. and the samples were analysed for their lactose content using an HPLC method.

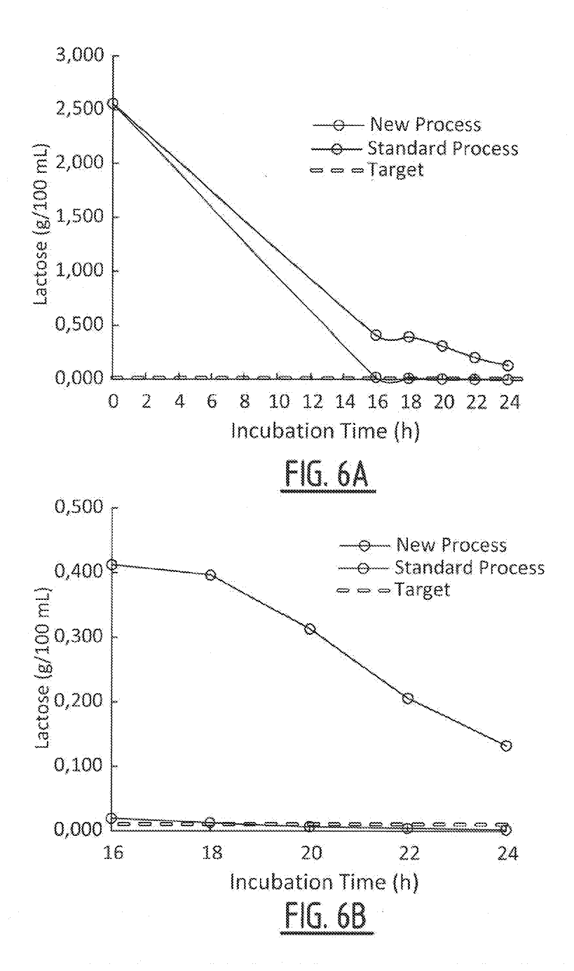

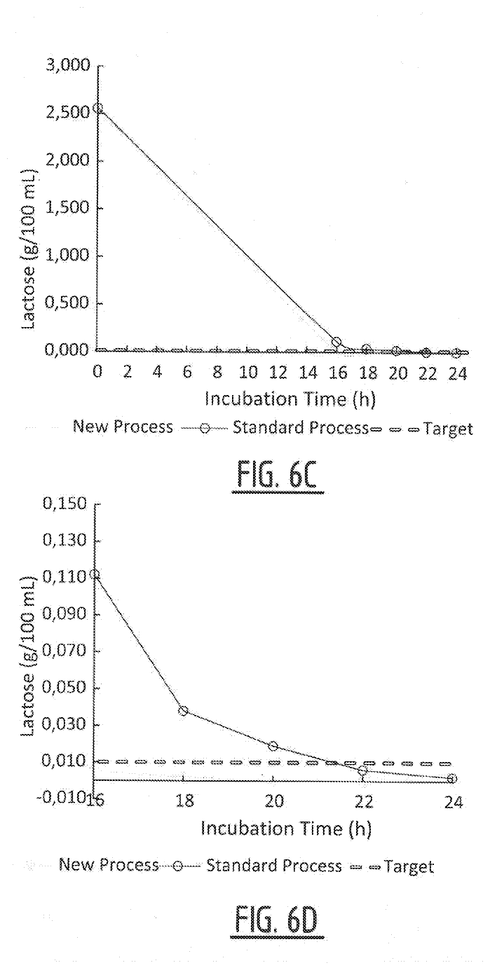

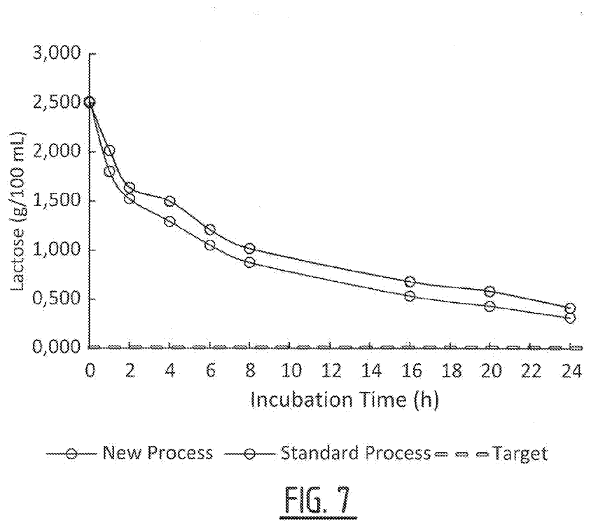

From the results obtained from the hydrolysis analysis (FIGS. 6 and 7) it can be concluded that the new process provides a more efficient process.

FIG. 5 shows the lactose content in the milk plotted against time of hydrolysation according to the system of FIG. 2 or 3, wherein FIG. 5A shows the process according to the invention over a time interval of 32 hours, and FIG. 5B shows the process over in the time interval of 28 hours to 32 hours. It is noted that the top line in FIG. 5B corresponds to the process according to the invention, and the bottom line corresponds to the process according to a standard process.

FIG. 6 shows the lactose content in the milk plotted against time of hydrolysation according to the system of FIG. 4, wherein FIG. 6A shows the process according to the invention over a time interval of 24 hours, and FIG. 6B shows the process over in the time interval of 16 hours to 24 hours. Furthermore, FIG. 6C and FIG. 6D show the process according to the invention comprising an enzyme dose which is three times as high compared to the results as shown in FIG. 6A and FIG. 6B. FIG. 6C shows the process according to the invention over a time interval of 32 hours, and FIG. 6D shows the process over in the time interval of 28 hours to 32 hours. It is noted that the top line of FIGS. 6A to 6D corresponds to the process according to a standard process and the bottom line corresponds to the process according to the invention. Thus, the process according to the invention is more efficient and effective compared to a conventional process.

FIG. 7 shows the lactose content in the milk plotted against time of hydrolysation according to the system of FIG. 4 when using larger volumes to hydrolyse to prove the system works as sufficient at large scale as it does on pilot scale. It is noted that the top line of FIG. 7 corresponds to the process according to a standard process and the bottom line corresponds to the process according to the invention. Thus, the process according to the invention is more efficient and effective compared to a conventional process.

The present invention is by no means limited to the above-described preferred aspects and/or experiments thereof. The rights sought are defined by the following claims within the scope of which many modifications can be envisaged.

1. Process for producing lactose free milk or substantially lactose-free milk, comprising the steps of:
a) ultra-filtering of milk providing a UF-permeate stream and a UF-retentate stream;
b) hydrolysing the UF-retentate by means of lactase;
c) nano-filtering the UF-permeate providing a NF-permeate stream and a NF-retentate stream; and
d) mixing the hydrolysed UF-retentate stream of step b) with the NF-permeate stream of step c) providing a lactose free or substantially lactose free milk,
further comprising a second filtration step from the first retentate stream for filtering the first NF-retentate stream providing a second NF-retentate stream and a second NF-permeate stream.

2. Process according to claim 1, further comprising a third filtration step from the second retentate stream for filtering the second NF-retentate stream providing a third NF-retentate stream and a third NF-permeate stream.

3. Process according to any one of the preceding claims, wherein the NF-permeate stream is provided to the UF-permeate.

4. Process according to any one of the preceding claims, wherein at least part of the NF-permeate streams is provided to the UF-permeate.

5. Process according to any one of the preceding claims, further comprising a measurement step wherein the measurement step comprises measuring the concentration of one or more element selected from the group of natrium, magnesium, calcium, protein, lactose, phosphorous, dry matter, and ash.

6. Process according to claim 5, further comprising a controlling step of the UF-permeate stream and/or UF-retentate stream based on the measurement of the concentration of natrium, magnesium, calcium, protein, lactose, phosphorous, dry matter, and/or ash.

7. Process according to any one of the preceding claims, using a volume concentration factor in the range of 3.5 to 6.5, preferably in the range of 3.7 to 5.5, most preferably in the range of 4 to 5, to provide the NF-retentate stream and NF-permeate stream of step c).

8. Process according to any one of the preceding claims, using a volume concentration factor in the range of 2.5 to 6.5 to provide the second NF-retentate stream and/or second NF-permeate stream.

9. Process according to any one of the claims 2 to 8 when dependent on claim 2, using a volume concentration factor in the range of 2.5 to 6.5 to provide the third NF-retentate stream and third NF-permeate stream.

10. Process according to any of the preceding claims, wherein the step of hydrolysing the UF-retentate is performed at a temperature range of 4° C. to 10° C., preferably in the range of 5° C. to 8° C., more preferably in the range of 6° C. to 7° C.

11. Process according to any of the preceding claims, wherein the step of hydrolysing the UF-retentate is performed for at most 24 hours, preferably for at most 20 hours, more preferably about 16 hours.

12. Process according to any of the preceding claims, wherein the step of nano-filtering the UF-permeate is performed at a temperature range of 4° C. to 15° C.

13. Process according to any of the preceding claims, wherein the step of ultra-filtering is performed at a concentration factor in the range of 1.8 to 2.2, preferably in the range of 1.9 to 2.1, more preferably at a concentration factor of about 2.

14. Process according to any of the preceding claims, wherein the step of ultra-filtering is performed at a temperature range from 45° C. to 55° C.

15. Lactose free milk or substantially lactose free milk obtained by the process according to any one of the preceding claims.

16. Lactose free milk or substantially lactose free milk according to claim 15, wherein the concentration of lactose is less than 0.05 wt %, preferably less than 0.02 wt %, more preferably less than 0.01 wt %.

17. Lactose free milk or substantially lactose free milk according to claim 15 or 16, wherein the concentration of ash is in the range of 0.6 g/100 ml to 1.1 g/100 ml.

18. Lactose free milk according to claim 15, 16, or 17, wherein the concentration of dry matter is in the range of 8.5 g/100 ml to 10 g/100 ml.

19. Lactose free milk or substantially lactose free milk according to any one of the claims 15 to 18, wherein the concentration of calcium is 100 mg/100 ml to 135 mg/100 ml.

20. Lactose free milk or substantially lactose free milk according to any one of the claims 15 to 19, wherein the concentration of phosphorus is 90 mg/100 ml to 120 mg/100 ml.

21. Lactose free milk product or substantially lactose free milk product selected from the group of infant formula, adult formula, yoghurt, comprising the lactose free milk according to any one of the claims 16 to 21.

22. Lactose free milk or substantially lactose free milk according to any one of the claims 15 to 20 or lactose free milk product or substantially lactose free milk product of claim 21, for use in a method to prevent or relieve disorders caused by lactose intolerance.

23. A system for producing lactose free milk or substantially lactose free milk, comprising:
a milk tank (101);
a UF-device (103) arranged to receive a milk stream (102) and configured to provide a UF-permeate stream (108) and a UF-retentate stream (104);
a hydrolysing tank (105) arranged to receive and hydrolyse said UF-retentate stream (104) and provide a hydrolysed UF-retentate stream (106);
a NF-device (109) comprising at least one NF-stage (110) configured to receive said UF-permeate stream (108) and to provide a NF-permeate stream (112) and a NF-retentate stream (111);
further comprising a further NF-stage (113, 116) wherein each following NF-stage (113, 116) is configured to receive the NF-retentate stream of the previous NF-stage (110, 113) and each NF-permeate stream (112, 115, 118) is configured to be delivered to the lactose free milk tank (104) and/or to the UF-permeate stream; and
a lactose free milk tank (107) configured to receive and combine said NF-permeate stream (112, 115, 118) with said hydrolysed UF-retentate stream (106) into said lactose free milk.

24. The system according to claim 23, further comprising valve means (119, 120, 121) configured to separate each permeate stream (112, 115, 118), wherein each separated permeate stream (112a, 112b, 115a, 115b, 118a, 118b) is configured to be delivered to the lactose free milk tank (107) or to the UF-permeate stream.
